(19) United States
(12) Patent Application Publication
(10) Pub. No.: US 2026/0114530 A1
(43) Pub. Date: Apr. 30, 2026

(54) SYSTEMS FOR GENERATING CUSTOMIZED EYELASH EXTENSIONS

(71) Applicant: L'Oreal, Paris (FR)

(72) Inventors: Charlotte Colbois, Paris (FR); Gregoire Charraud, Jersey City, NJ (US); Rafael Feliciano, New Providence, NJ (US)

(73) Assignee: L'Oreal, Paris (FR)

(21) Appl. No.: 18/930,939

(22) Filed: Oct. 29, 2024

(51) Int. Cl. A41G 5/02; A45D 44/00; G06T 19/00

(52) U.S. Cl. CPC A41G 5/02; A45D 44/005; G06T 19/006; G06T 2210/22

(57) ABSTRACT

In some embodiments, a computer-implemented method of creating an eyelash extension is provided. A computing system receives an image of a face of a subject. The computing system detects one or more eye landmarks within the image, and adjusts an eyelash extension template based on the one or more eye landmarks. The computing system generates an augmented reality presentation that includes the image of the face of the subject and the adjusted eyelash extension template.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some embodiments, a computer-implemented method of creating an eyelash extension is provided. A computing system receives an image of a face of a subject. The computing system detects one or more eye landmarks within the image, and adjusts an eyelash extension template based on the one or more eye landmarks. The computing system generates an augmented reality presentation that includes the image of the face of the subject and the adjusted eyelash extension template.

In some embodiments, a non-transitory computer-readable medium is provided. The non-transitory computer-readable medium has computer-executable instructions stored thereon that, in response to execution by one or more processors of a computing system, cause the computing system to perform actions for creating an eyelash extension, the actions comprising: receiving, by the computing system, an image of a face of a subject; detecting, by the computing system, one or more eye landmarks within the image; adjusting, by the computing system, an eyelash extension template based on the one or more eye landmarks; and generating, by the computing system, an augmented reality presentation that includes the image of the face of the subject and the adjusted eyelash extension template.

In some embodiments, a computing system is provided that comprises circuitry for receiving an image of a face of a subject; circuitry for detecting one or more eye landmarks within the image; circuitry for adjusting an eyelash extension template based on the one or more eye landmarks; and circuitry for generating an augmented reality presentation that includes the image of the face of the subject and the adjusted eyelash extension template.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates a non-limiting example embodiment of a system for generating customized eyelash extensions, according to various aspects of the present disclosure.

FIG. 2A, FIG. 2B, FIG. 3A, and FIG. 3B illustrate aspects of a non-limiting example of an eyelash extension creation system according to various aspects of the present disclosure.

FIG. 4 is a block diagram that illustrates aspects of a non-limiting example embodiment of an eyelash extension interface computing system according to various aspects of the present disclosure.

FIG. 5A-FIG. 5B are a flowchart that illustrates a non-limiting example embodiment of a method of creating an eyelash extension according to various aspects of the present disclosure.

FIG. 6 illustrates a non-limiting example embodiment of an eyelash extension interface computing system displaying an image of a face of a subject.

FIG. 7 illustrates a non-limiting example of a result of a determination of a cropped image area based on one or more eye landmarks, according to various aspects of the present disclosure.

FIG. 8 illustrates a non-limiting example of a result of a determination of extension attachment points based on the cropped image of the eye region, according to various aspects of the present disclosure.

FIG. 9 is an illustration of non-limiting example adjustments to an eyelash extension template, according to various aspects of the present disclosure.

FIG. 10 illustrates a non-limiting example embodiment of an augmented reality presentation according to various aspects of the present disclosure.

FIG. 11 illustrates a non-limiting example embodiment of an interface for receiving a modification to one or more attributes of the eyelash extension template, according to various aspects of the present disclosure.

### DETAILED DESCRIPTION

Recently, systems have been developed that allow for the automatic creation and application of eyelash extensions. However, while these systems are capable of creating and applying eyelash extensions based on eyelash extension definitions provided to them, there are currently no solutions for interactive evaluation and creation of eyelash extension definitions to be used to control the system for creation and application.

In some embodiments of the present disclosure, computing systems are provided that generate templates for creating eyelash extensions. By using a camera associated with the computing system, the computing system adjusts a template for the eyelash extension based on eye landmarks in an image of a face of a subject, such that the eyelash extension template is adjusted to an appropriate size and shape for the subject. In some embodiments, the computing system may generate an augmented reality presentation in which the eyelash extension template is presented as if it were applied to the subject, and one or more characteristics of the eyelash extension template may be adjusted in response to the augmented reality presentation until an acceptable eyelash extension template is determined. Instructions are then transmitted that cause an eyelash extension based on the adjusted eyelash extension template to be created and applied to the subject.

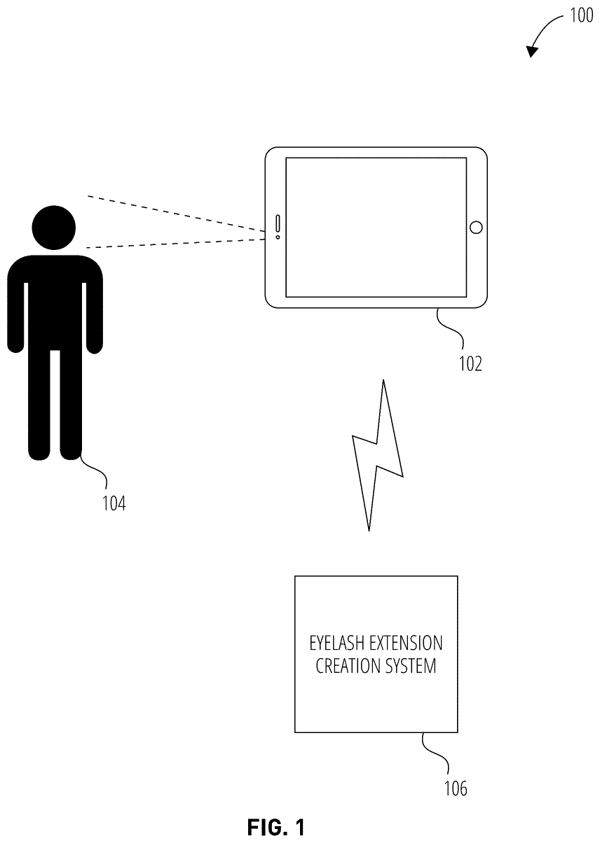

FIG. 1 is a schematic illustration of a non-limiting example embodiment of a system for creating and applying eyelash extensions, according to various aspects of the present disclosure. In the system 100, an eyelash extension interface computing system 102 is used to capture an image of a face of a subject 104. The eyelash extension interface computing system 102 uses the image to adjust one or more attributes of an eyelash extension template to be suitable for the subject 104, and generates an augmented reality presentation of the eyelash extension as it would be applied to the subject 104. Further adjustments may be made to the eyelash extension template based on the augmented reality presentation. Once an adjusted eyelash extension template has been approved, instructions are transmitted to an eyelash extension creation system 106 to create the eyelash extension and to apply it to the subject 104.

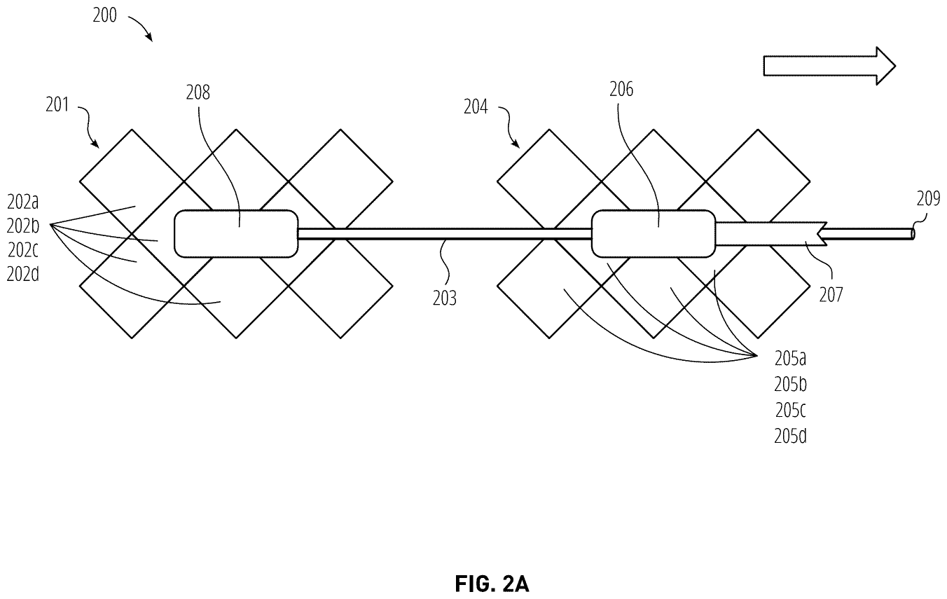

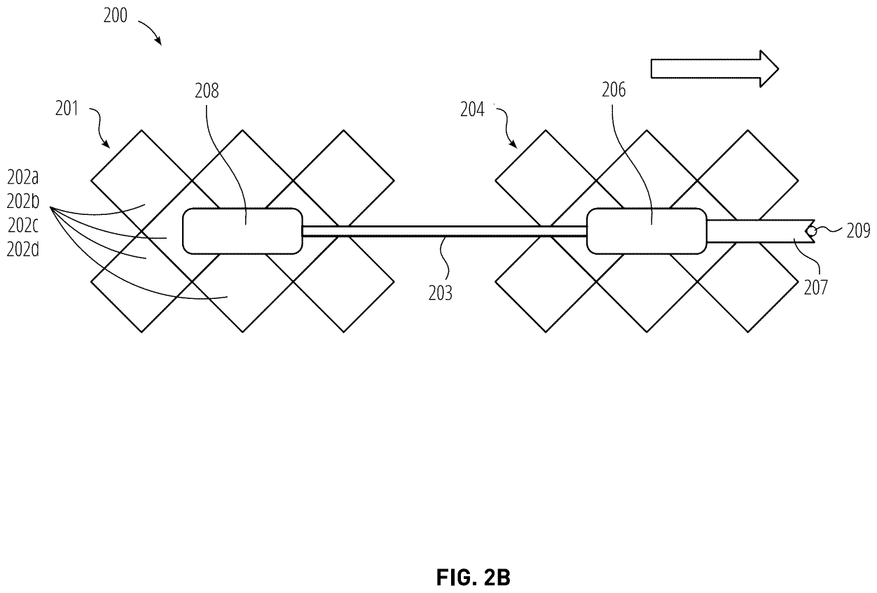

FIG. 2A, FIG. 2B, FIG. 3A, and FIG. 3B illustrate aspects of a non-limiting example of an eyelash extension creation system according to various aspects of the present disclosure. FIG. 2A and FIG. 2B illustrate a non-limiting example embodiment of a micro-robot gripping system, while FIG. 3A and FIG. 3B illustrate a non-limiting example embodiment of a micro-robot crane system. To create and apply an eyelash extension, the eyelash extension creation system receives instructions that indicate a length, curve, and location of one or more new lashes to be applied to the subject 104 for the eyelash extension. For each of the one or more lashes, the micro-robot crane system separates the existing lashes of the subject that flank the desired location for the new lash, and the micro-robot gripping system applies the new lash in the desired location.

In FIG. 2A and FIG. 2B, the micro-robot gripping system 200 includes a first micro-robot 201 having a first plurality of magnets 202a, 202b, 202c, . . . 202d and a wire comb 203, and a second micro-robot 204 having a second plurality of magnets 205a, 205b, 205c, . . . 205d, a tube 206, and a gripper 207.

In some embodiments, the first micro-robot 201 includes a first plurality of magnets 202a, 202b, 202c . . . 202d. In some embodiments, the first plurality of magnets 202a, 202b, 202c, . . . 202d is arranged in an array of alternating magnetization, as explained herein. In some embodiments, the first plurality of magnets 202a, 202b, 202c, . . . 202d is a plurality of NdFeB magnets.

In some embodiments, the first micro-robot 201 also includes a holder 208 configured to retain the wire comb 203. In some embodiments, the wire comb 203 is configured to slide into the holder 208. In some embodiments, the wire comb 203 is integrated into the holder 208.

The wire comb 203 may be made of metal, ceramic, carbon, plastic, or a combination thereof. In some embodiments, the wire comb 203 includes an attachment end 209. The attachment end 209 may be disposed at substantially a 45-degree angle from the wire comb 203 to form a “hook” shape.

In some embodiments, the second micro-robot 204 includes a second plurality of magnets 205a, 205b, 205c . . . 205d. In some embodiments, the second plurality of magnets 205a, 205b, 205c . . . 205d is arranged in an array of alternating magnetization, as explained herein. In some embodiments, the second plurality of magnets 205a, 205b, 205c . . . 205d is a plurality of NdFeB magnets.

In some embodiments, the second micro-robot 204 further includes a tube 206. The tube 206 is configured to slide along the wire comb 203 of the first micro-robot 201. In this manner, the second micro-robot 204 may move back and forth (such as in the direction of the arrow in FIG. 2A) along the wire comb 203.

In some embodiments, the second micro-robot 204 further comprises a gripper 207.

In some embodiments, the gripper 207 is configured to mate with the attachment end 209 of the wire comb 203. In some embodiments, the gripper 207 has a “V-shaped” end.

In operation, the first micro-robot 201 is secured to a first location. In some embodiments, the first location is on a substrate. The second micro-robot 204 may then be slid along the wire comb 203 through the tube 206 of the second micro-robot 204. In some embodiments, the second micro-robot 204 slides towards the attachment end 209 of the wire comb 203, as shown in FIG. 2A and FIG. 2B, such that the gripper 207 contacts the attachment end 209. In some embodiments, an eyelash or cluster of eyelashes (not pictured in FIG. 2A-FIG. 2B) is gripped between the gripper 207 and the attachment end 209. The first micro-robot 201 and/or the second micro-robot 204 may then be positioned to apply the eyelash or cluster of eyelashes to an eyelid. In some embodiments, the first micro-robot 201 and the second micro-robot 204 are configured to move together, such that the distance between the first micro-robot 201 and the second micro-robot 204 does not change. Once the micro-robots 201, 204 are in position, the gripper 207 may be retracted away from the attachment end 209, such as by moving the second micro-robot 204 along the wire comb 203 in the opposite direction. Then, the eyelash or eyelash cluster is applied to the eyelid. In some embodiments, the eyelash or eyelash cluster may include an adhesive, such as eyelash glue. In some embodiments, a subject 104 may apply adhesive, magnetic eyeliner, or the like to their eyes before using system 200. In some embodiments, the second micro-robot 204 may remain in place for a set period of time (such as 60 seconds) before retracting along the wire comb 203 to ensure the eyelash or cluster of eyelashes remain in place, prior to releasing the eyelash or cluster of eyelashes.

In some embodiments, throughout this operation, the first micro-robot 201 and/or the second micro-robot 204 may slide across a substrate. In other embodiments, the first micro-robot 201 and/or the second micro-robot 204 may levitate across a substrate. In some embodiments, the first micro-robot 201 and the second micro-robot 204 are configured to slide across or levitate over a flexible substrate.

In FIG. 3A-FIG. 3B, the illustrated non-limiting example embodiment of the micro-robot crane system 300 includes a single micro-robot crane. The micro-robot crane system 300 may include a back micro-robot 301 having a first plurality of magnets 302a, 302b, 302c . . . 302d, a rotary bearing 303, and a separation arm 304 including a separator tip 305. In some embodiments, the micro-robot crane system 300 further includes a front micro-robot 306 having a second plurality of magnets 307a, 307b, 307c . . . 307d, a mount 308, and mechanical stop 309.

In some embodiments, the back micro-robot 301 includes a first plurality of magnets 302a, 302b, 302c . . . 302d. In some embodiments, the first plurality of magnets 302a, 302b, 302c . . . 302d is arranged in an array of alternating magnetization. In some embodiments, the first plurality of magnets 302a, 302b, 302c . . . 302d is a plurality of NdFeB magnets.

In some embodiments, the back micro-robot 301 further includes a rotary bearing 303. The rotary bearing 303 is configured to retain the separation arm 304, and allow the separation arm 304 to move up and down over the mount 308 of the front micro-robot 306, as shown in FIG. 3B.

In some embodiments, the separation arm 304 includes a separator tip 305 configured to contact a lash line and separate one or more lashes from one another, as shown in FIG. 3B. In some embodiments, the separator tip 305 is disposed at an angle from the separation arm 304.

In some embodiments, the front micro-robot 306 includes a second plurality of magnets 307a, 307b, 307c . . . 307d. In some embodiments, the second plurality of magnets 307a, 307b, 307c . . . 307d is arranged in an array of alternating magnetization. In some embodiments, the second plurality of magnets 307a, 307b, 307c . . . 307d is a plurality of NdFeB magnets.

The front micro-robot 306 may further include a mount 308 configured to slide along the separation arm 304. The mount 308 is configured to hold the separation arm 304 and slide backwards and forwards along the separation arm 304 to raise and lower the separation arm 304, as shown in FIG. 3B.

In some embodiments, the front micro-robot 306 further includes a mechanical stop 309, which further retains the separation arm 304. The mechanical stop 309 may prevent the separation arm from disengaging from or falling from the mount 308.

In operation, the back micro-robot 301 may remain stationary. The front micro-robot 306 may move backwards, in direction B. As the front micro-robot 306 moves in direction B, the separation arm 304 is raised upwards with the rotary bearing in the direction U. Because the separation arm 304 contacts mount 308, as the front micro-robot 306 moves backwards, the mount 308 increases an angle between the substrate 310 and the separation arm 304. In this manner, the separator tip 305 can contact a lash line of an eyelid, as shown in FIG. 3B. The separator tip 305 may fit between individual lashes of a plurality of lashes L1, L2, L3 . . . LN.

In some embodiments, after contacting the lash line with the separator tip 305, the back micro-robot 301 and the front micro-robot 306 may move together in a direction perpendicular to direction B to separate adjacent eyelashes.

In some embodiments, throughout this operation, the back micro-robot 301 and/or the front micro-robot 306 may slide across a substrate 310. In other embodiments, the back micro-robot 301 and/or the front micro-robot 306 may levitate across a substrate 310. In some embodiments, the back micro-robot 301 and the front micro-robot 306 are configured to slide across or levitate over a flexible substrate.

Further details regarding an eyelash extension creation system that includes the micro-robot gripping system and the micro-robot crane system illustrated in FIG. 2A, FIG. 2B, FIG. 3A, and FIG. 3B are provided in commonly owned, co-pending U.S. application Ser. No. 18/649,034, filed Apr. 29, 2024, the entire disclosure of which is hereby incorporated by reference herein for all purposes.

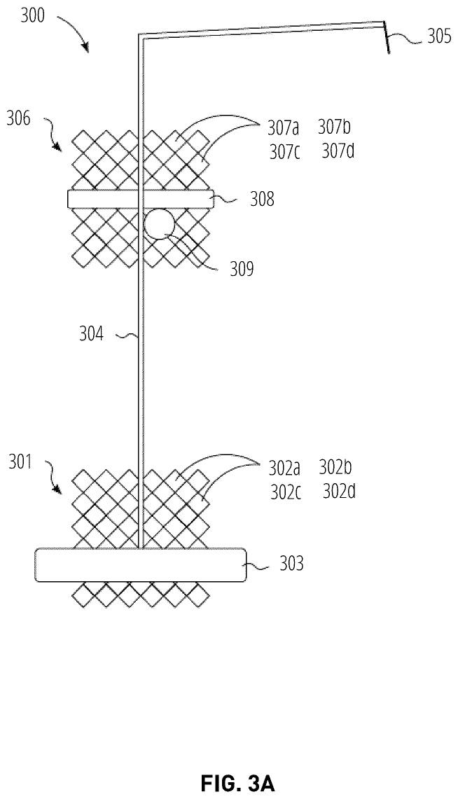

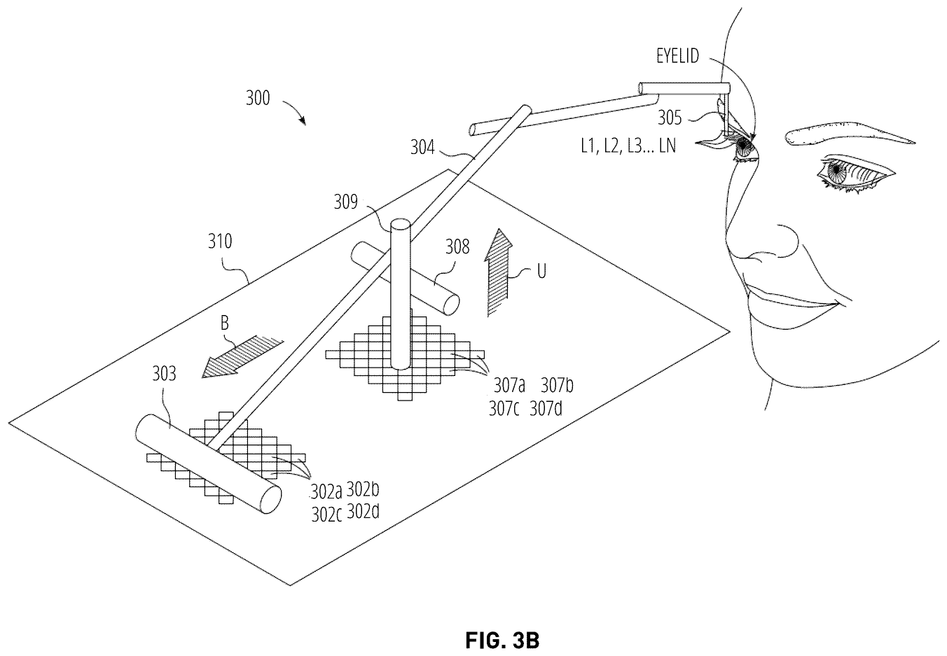

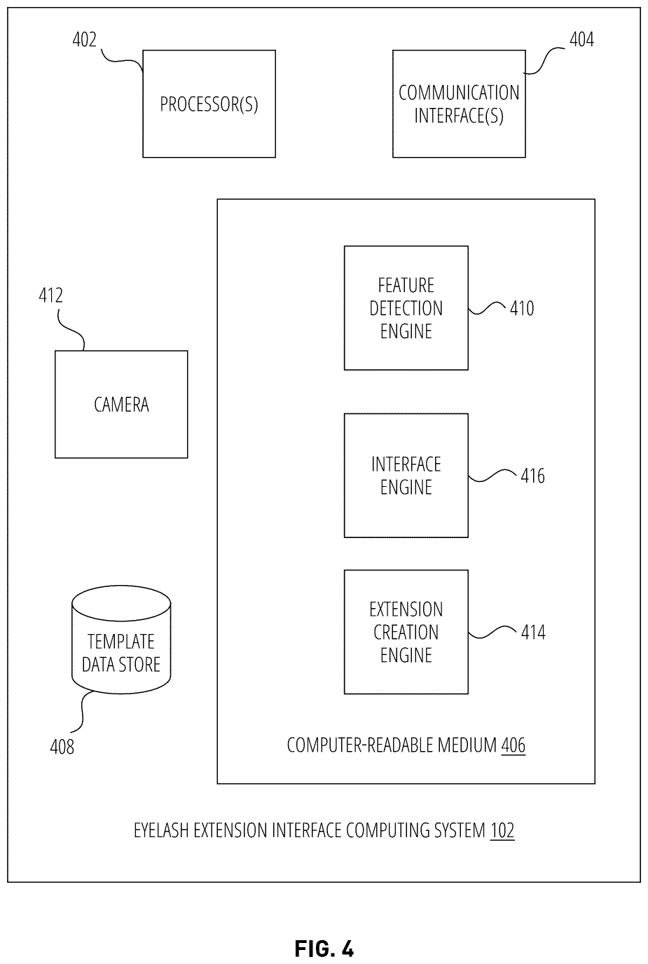

FIG. 4 is a block diagram that illustrates aspects of a non-limiting example embodiment of an eyelash extension interface computing system according to various aspects of the present disclosure. The illustrated eyelash extension interface computing system 102 may be implemented by any computing device or collection of computing devices, including but not limited to a desktop computing device, a laptop computing device, a mobile computing device, a server computing device, a computing device of a cloud computing system, and/or combinations thereof. In typical embodiments, the eyelash extension interface computing system 102 is implemented using a computing device that includes all of the illustrated components, such as a smartphone, a tablet, or a laptop/desktop computing device that has a camera.

As shown, the eyelash extension interface computing system 102 includes one or more processors 402, one or more communication interfaces 404, a template data store 408, a camera 412, and a computer-readable medium 406.

In some embodiments, the processors 402 may include any suitable type of general-purpose computer processor. In some embodiments, the processors 402 may include one or more special-purpose computer processors or AI accelerators optimized for specific computing tasks, including but not limited to graphical processing units (GPUs), vision processing units (VPUs), and tensor processing units (TPUs).

In some embodiments, the communication interfaces 404 include one or more hardware and or software interfaces suitable for providing communication links between components. The communication interfaces 404 may support one or more wired communication technologies (including but not limited to Ethernet, FireWire, and USB), one or more wireless communication technologies (including but not limited to Wi-Fi, WiMAX, Bluetooth, 2G, 3G, 4G, 5G, and LTE), and/or combinations thereof.

In some embodiments, the camera 412 may include any type of camera, including a two-dimensional visible light camera, a stereoscopic camera, or a time-of-flight camera. In some embodiments, more than one type of camera 412 may be included, such as a visible light camera and a time-of-flight camera, and data from both cameras may be used together. In some embodiments, the camera 412 may be an integrated camera, such as a front-facing or rear-facing camera of a tablet or smartphone, or a screen-mounted webcam of a laptop computing device. In some embodiments, the camera 412 may be an external camera, such as a USB camera.

As shown, the computer-readable medium 406 has stored thereon logic that, in response to execution by the one or more processors 402, cause the eyelash extension interface computing system 102 to provide a feature detection engine 410, an interface engine 416, and an extension creation engine 414.

As used herein, “computer-readable medium” refers to a removable or nonremovable device that implements any technology capable of storing information in a volatile or non-volatile manner to be read by a processor of a computing device, including but not limited to: a hard drive; a flash memory; a solid state drive; random-access memory (RAM); read-only memory (ROM); a CD-ROM, a DVD, or other disk storage; a magnetic cassette; a magnetic tape; and a magnetic disk storage.

In some embodiments, the feature detection engine 410 is configured to receive images captured by the camera 412, and to detect facial features shown therein. In some embodiments, the interface engine 416 is configured to generate augmented reality presentations that depict eyelash extensions as they would look as applied to the subject 104.

In some embodiments, the extension creation engine 414 is configured to load eyelash extension templates from the template data store 408, to adjust them based on the facial features detected by the feature detection engine 410 and/or adjustments collected by the interface engine 416, and to transmit instructions to the eyelash extension creation system 106 to create and apply the eyelash extension to the subject 104.

Further description of the configuration of each of these components is provided below.

As used herein, “engine” refers to logic embodied in hardware or software instructions, which can be written in one or more programming languages, including but not limited to C, C++, C#, COBOL, JAVA™, PHP, Perl, HTML, CSS, JavaScript, VBScript, ASPX, Go, and Python. An engine may be compiled into executable programs or written in interpreted programming languages. Software engines may be callable from other engines or from themselves. Generally, the engines described herein refer to logical modules that can be merged with other engines, or can be divided into sub-engines. The engines can be implemented by logic stored in any type of computer-readable medium or computer storage device and be stored on and executed by one or more general purpose computers, thus creating a special purpose computer configured to provide the engine or the functionality thereof. The engines can be implemented by logic programmed into an application-specific integrated circuit (ASIC), a field-programmable gate array (FPGA), or another hardware device.

As used herein, “data store” refers to any suitable device configured to store data for access by a computing device. One example of a data store is a highly reliable, high-speed relational database management system (DBMS) executing on one or more computing devices and accessible over a high-speed network. Another example of a data store is a key-value store. However, any other suitable storage technique and/or device capable of quickly and reliably providing the stored data in response to queries may be used, and the computing device may be accessible locally instead of over a network, or may be provided as a cloud-based service. A data store may also include data stored in an organized manner on a computer-readable storage medium, such as a hard disk drive, a flash memory, RAM, ROM, or any other type of computer-readable storage medium. One of ordinary skill in the art will recognize that separate data stores described herein may be combined into a single data store, and/or a single data store described herein may be separated into multiple data stores, without departing from the scope of the present disclosure.

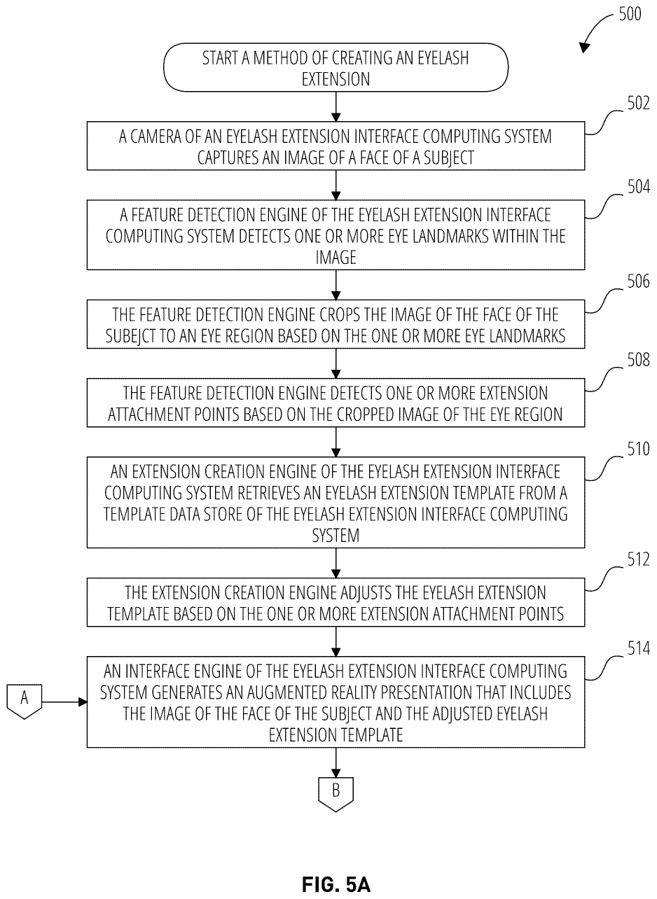

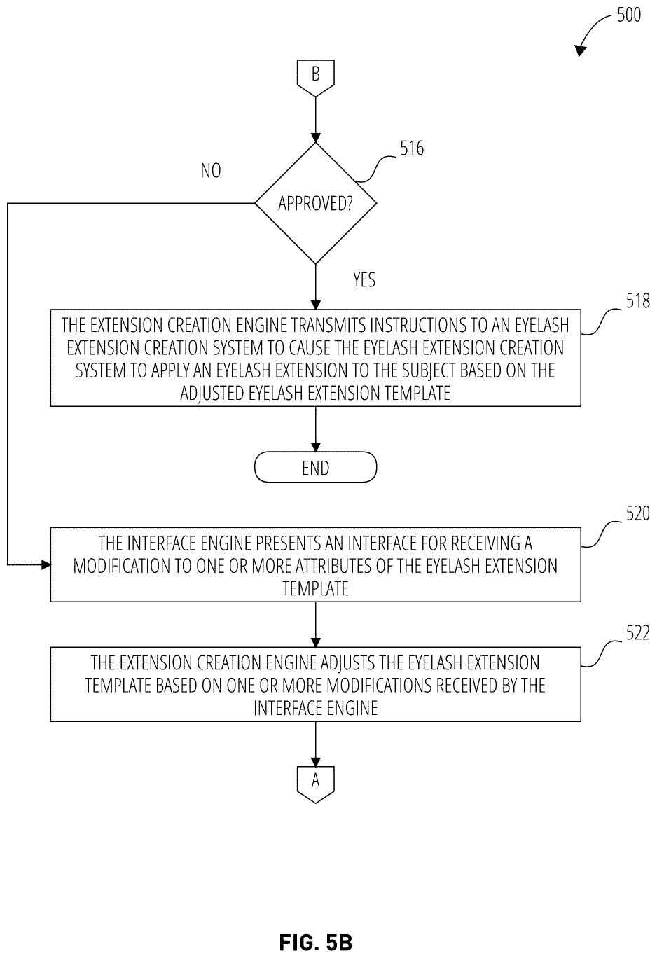

FIG. 5A-FIG. 5B are a flowchart that illustrates a non-limiting example embodiment of a method of creating an eyelash extension according to various aspects of the present disclosure. In the method 500, an eyelash extension is created and applied by using an eyelash extension interface computing system 102 to adapt an eyelash extension template as appropriate for a subject 104, to generate augmented reality presentations of the eyelash extension template as applied to the subject 104, and to transmit instructions to the eyelash extension creation system 106 to create and apply the eyelash extension as adjusted per the eyelash extension template to the subject 104.

From a start block, the method 500 proceeds to block 502, where a camera 412 of an eyelash extension interface computing system 102 captures an image of a face of a subject 104. The present disclosure refers to the processing of images to improve the clarity of the description, but in some embodiments, the method 500 may capture and process video of the face of the subject 104, as opposed to still images. In such embodiments, one or more of the frames in the video may be processed similarly to the still images as described herein.

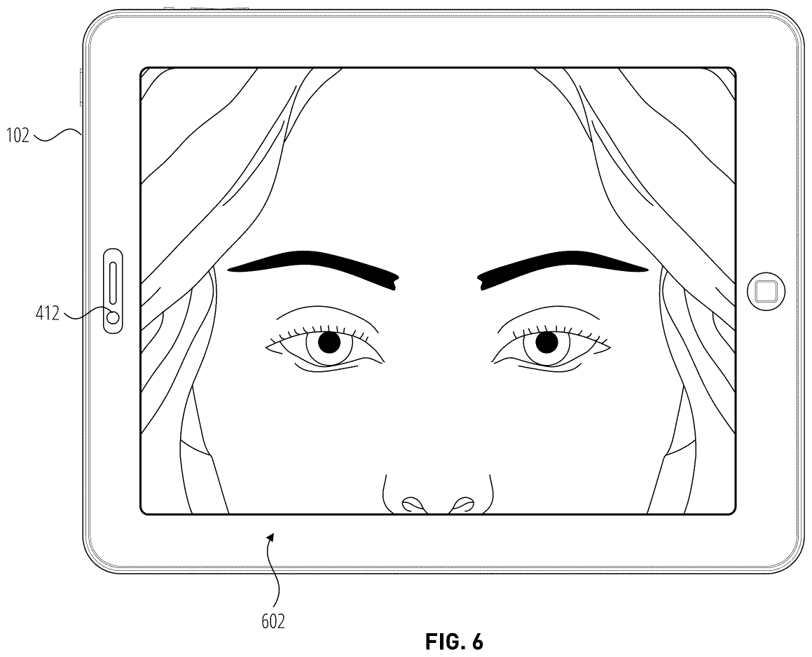

FIG. 6 illustrates a non-limiting example embodiment of an eyelash extension interface computing system displaying an image of a face of a subject. The eyelash extension interface computing system 102 is a tablet computing device, and the image 602 displayed on the display of the eyelash extension interface computing system 102 is captured by a front-facing camera 412 of the eyelash extension interface computing system 102.

Returning to FIG. 5A, at block 504, a feature detection engine 410 of the eyelash extension interface computing system 102 detects one or more eye landmarks within the image. Any suitable technique known to one of ordinary skill in the art may be used to detect the eye landmarks. In some embodiments, an available utility, such as a software development kit (SDK) or application programming interface (API) provided by ModiFace for face tracking or virtual try on, may be used to implement the feature detection engine 410 and to detect the one or more eye landmarks. Any landmarks detectable in the image that are suitable for determining a location of an eye within the image may be used, including but not limited to a medial canthus, a lateral canthus, a border of a lower eyelid, a border of an upper eyelid, an eyebrow, or other features of either eye.

At block 506, the feature detection engine 410 crops the image of the face of the subject 104 to an eye region based on the one or more eye landmarks. In some embodiments, the feature detection engine 410 may use the eye landmarks detected for each eye to determine the approximate location of the eyes in the image, and may crop the image based on the locations of the eye landmarks. In some embodiments, the feature detection engine 410 may crop the image separately for each eye (i.e., make two small images, each showing one eye). In some embodiments, the feature detection engine 410 may crop the image to a single region that shows both eyes.

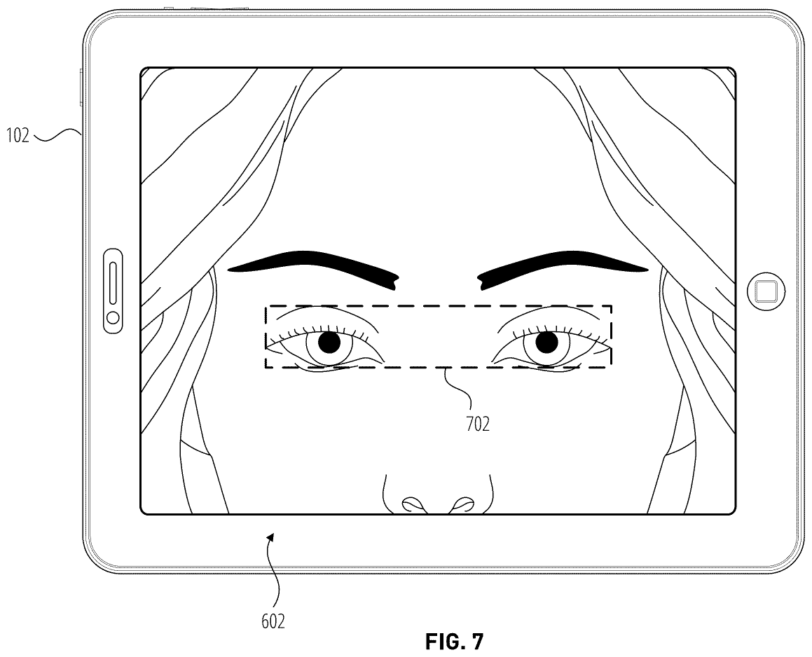

FIG. 7 illustrates a non-limiting example of a result of a determination of a cropped image area based on one or more eye landmarks, according to various aspects of the present disclosure. As shown, a cropped image area 702 has been determined based on the lateral canthus of each eye, the upper edge of the upper eyelid, and the upper edge of the lower eyelid. In some embodiments, instead of using the exact location of these landmarks as the border of the cropped image area 702, an offset from the landmark (e.g., a predetermined number of pixels away from the landmark) may be used as the border of the cropped image area 702. In some embodiments, the eyelash extension interface computing system 102 may create a new image that includes only the cropped image area 702, and may use the new image in the feature detection engine 410 for further processing. In some embodiments, the eyelash extension interface computing system 102 may provide the borders of the cropped image area 702 to the feature detection engine 410, and the feature detection engine 410 may limit its processing of the original image 602 to the borders of the cropped image area 702 without creating a new image.

Returning to FIG. 5A, at block 508, the feature detection engine 410 detects one or more extension attachment points based on the cropped image of the eye region. As with the detection of the eye landmarks, any suitable technique may be used, including but not limited to using extension attachment points detected by ModiFace or another available landmark detection utility. The one or more extension attachment points may coincide with bases of eyelashes detected in the image, or may coincide with the lower edge of the upper eyelid as detected in the image. In some embodiments, a predetermined number of extension attachment points extending between the medial canthus and lateral canthus may be detected. The predetermined number may be based on a configurability of the eyelash extension creation system 106, a processing power of the eyelash extension interface computing system 102, or any other basis. One technical improvement provided by the present disclosure is provided by the cropping of the image to the eye region at block 506—the detection of extension attachment points can be computationally expensive, and so reducing the size of the image used at block 508 to detect the extension attachment points reduces the computational burden on the eyelash extension interface computing system 102 and increases the performance of the system.

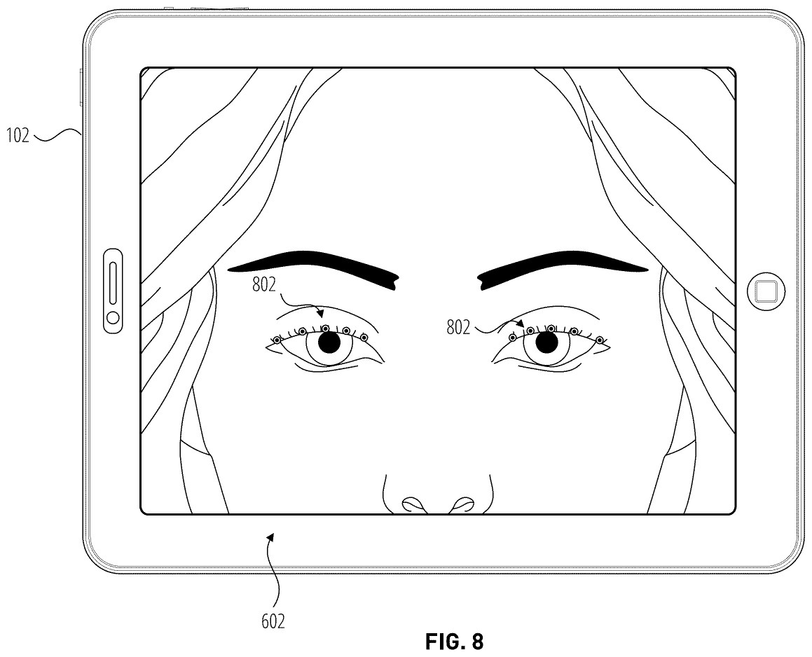

FIG. 8 illustrates a non-limiting example of a result of a determination of extension attachment points based on the cropped image of the eye region, according to various aspects of the present disclosure. As shown, a plurality of extension attachment points 802 are illustrated on the lash line of each eye. In some embodiments, a lateral extension attachment point and a medial extension attachment point may be placed on the lash line, and a plurality of additional extension attachment points may be placed evenly along the lash line between the lateral extension attachment point and the medial extension attachment point. In some embodiments, the lateral extension attachment point may be placed at an offset from a landmark, such as the lateral canthus, and the medial extension attachment point may be placed at an offset from a landmark, such as the medial canthus. In some embodiments, the lateral extension attachment point and medial extension attachment point may be placed based on the ends of the natural lashes of the subject 104.

Returning to FIG. 5A, at block 510, an extension creation engine 414 of the eyelash extension interface computing system 102 retrieves an eyelash extension template from a template data store 408 of the eyelash extension interface computing system 102. In some embodiments, the eyelash extension template includes a definition of a number, location, thickness, length, curve, and/or other aspects of eyelashes in an eyelash extension. In some embodiments, the eyelash extension template may also include a two-dimensional image of an unmodified version of the eyelash extension, and/or a three-dimensional model of an unmodified version of the eyelash extension.

At block 512, the extension creation engine 414 adjusts the eyelash extension template based on the one or more extension attachment points. The extension creation engine 414 may adjust the eyelash extension template to coincide with the one or more extension attachment points by scaling the eyelash extension template in one or more dimensions to match a size of the eyelid indicated by the extension attachment points, by warping the eyelash extension template in one or more dimensions to match a shape of the eyelid indicated by the extension attachment points, and/or in any other suitable way.

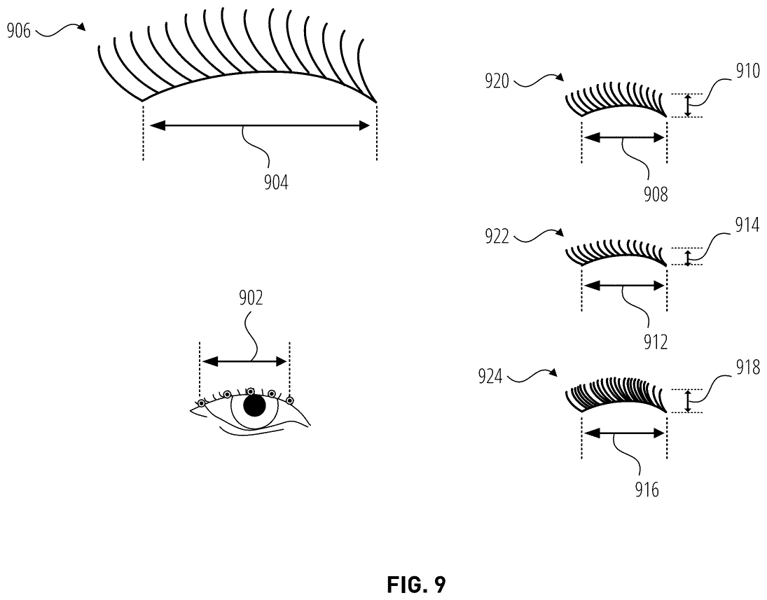

FIG. 9 is an illustration of non-limiting example adjustments to an eyelash extension template, according to various aspects of the present disclosure. For purposes of this discussion, the various illustrations in FIG. 9 are shown at the same scale in relation to each other.

At the upper left is an eyelash extension template 906. The eyelash extension template 906 includes a two-dimensional image or three-dimensional model that represents the appearance of the eyelash extension template. In some embodiments, the eyelash extension template 906 may also include instructions usable by an eyelash extension creation system 106 to create the eyelash extension and attach it to the subject 104, such as a relative location, a length, and a curve of each lash in the eyelash extension. As shown, the eyelash extension template 906 has a template lash width 904.

At the lower left is the eye of the subject 104, taken from the image 602, with the extension attachment points defining a subject lash width 902. The subject lash width 902 is smaller than the template lash width 904, and so at block 512, the eyelash extension template 906 would be adjusted to match the subject lash width 902. At the upper right, a first adjusted eyelash extension template 920 is shown. The first adjusted eyelash extension template 920 has the same shape as the eyelash extension template 906, but has been scaled both horizontally so that the first adjusted width 908 matches the subject lash width 902, and vertically so that the first adjusted height 910 maintains the shape of the eyelash extension template 906 after having been resized horizontally.

Also shown are a second adjusted eyelash extension template 922 and a third adjusted eyelash extension template 924. In the second adjusted eyelash extension template 922, the second adjusted width 912 is also the same as the subject lash width 902, but the second adjusted height 914 has been reduced more than the first adjusted height 910. In the third adjusted eyelash extension template 924, the third adjusted width 916 matches the subject lash width 902 and the third adjusted height 918 matches the first adjusted height 910, but a density (e.g., a number of lashes in the eyelash extension) of the third adjusted eyelash extension template 924 has been increased from the density of the eyelash extension template 906. The second adjusted eyelash extension template 922 and third adjusted eyelash extension template 924 are examples of adjustments from the standard eyelash extension template 906 that may be made in response to input collected by a user interface, as will be discussed below.

Returning to FIG. 5A, at block 514, an interface engine 416 of the eyelash extension interface computing system 102 generates an augmented reality presentation that includes the image of the face of the subject and the adjusted eyelash extension template. In the augmented reality presentation, the image of the face of the subject 104 is shown with the adjusted eyelash extension template superimposed thereon, with the adjusted eyelash extension template located in a position that corresponds to the extension attachment points. In some embodiments, the augmented reality presentation is generated for both the left eye and the right eye of the subject 104, with appropriate adjusted eyelash extension templates used for each eye.

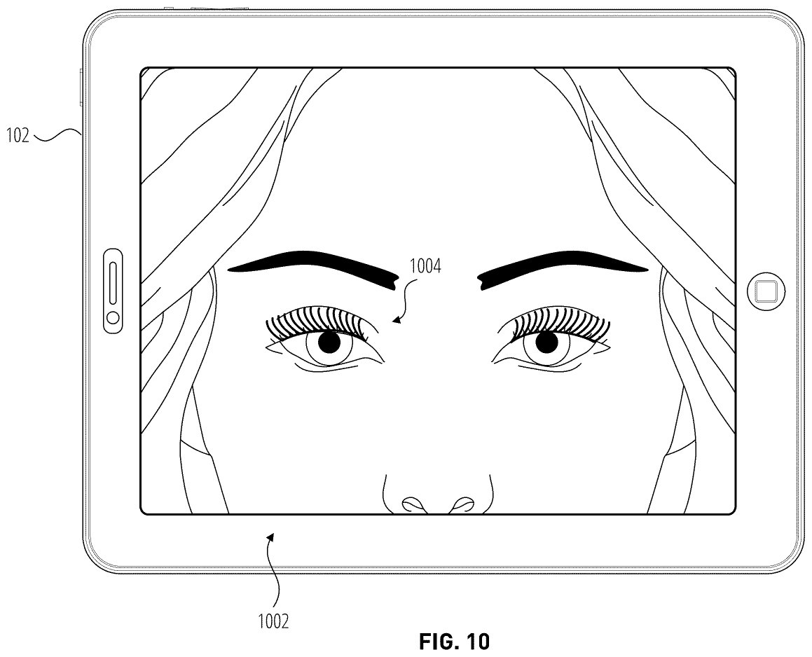

FIG. 10 illustrates a non-limiting example embodiment of an augmented reality presentation according to various aspects of the present disclosure. In FIG. 10, the augmented reality presentation 1002 includes the image of the face of the subject 104, as well as the adjusted eyelash extension template 1004 superimposed in the appropriate position with respect to each eye. In some embodiments, the interface engine 416 may use the position of facial landmarks in two or three dimensions to position and/or warp the two-dimensional image or three-dimensional model so that the adjusted eyelash extension template 1004 remains both in the proper position with respect to the face of the subject 104 and the proper shape with respect to an angle of the face of the subject 104 with respect to the camera 412.

Returning to the method 500 in FIG. 5A, after block 514 the method 500 proceeds to a continuation terminal (“terminal B”). From terminal B (FIG. 5B), the method 500 proceeds to decision block 516, where a determination is made regarding whether the eyelash extension shown in the augmented reality presentation is approved. In some embodiments, the interface presented by the interface engine 416 that includes the augmented reality interface may include interface elements that accept input indicating that the eyelash extension is approved or whether changes are desired. The determination at decision block 516 may be based on whether an interface element indicating approval was actuated, or whether an interface element requesting changes to the eyelash extension was actuated.

If the eyelash extension is not approved, then the result of decision block 516 is NO, and the method 500 proceeds to block 520. At block 520, the interface engine 416 presents an interface for receiving a modification to one or more attributes of the eyelash extension template. The interface may include one or more interface elements representing changes to the eyelash extension, including but not limited to changing the eyelash extension template to a different base template; changing one or more of a length, density, thickness, or curve of the eyelash extension, or any other suitable characteristic of the eyelash extension.

At block 522, the extension creation engine 414 adjusts the eyelash extension template based on one or more modifications received by the interface engine 416, and then returns via a continuation terminal (“terminal A”) to block 514 to generate an augmented reality presentation based on the modified eyelash extension template.

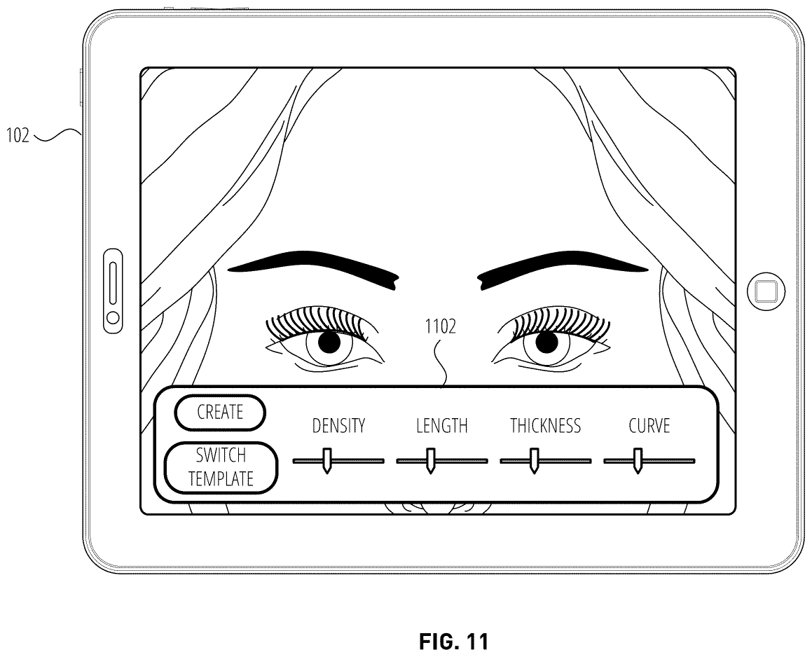

FIG. 11 illustrates a non-limiting example embodiment of an interface for receiving a modification to one or more attributes of the eyelash extension template, according to various aspects of the present disclosure. As shown, the interface includes a plurality of interface elements 1102 that allow for modification of attributes of the eyelash extension template, including a density, a length, a thickness, and a curve. Moving each slider may increase or decrease the attribute of the eyelash extension template. A “switch template” interface element may cause a list of eyelash extension templates to be presented, with each eyelash extension template having a distinct curve, thickness, density, length, and/or other attributes to create a given look. In some embodiments, the list of eyelash extension templates may include one or more recommended eyelash extension templates, which may be chosen based on the relative positions or shapes defined by one or more facial landmarks, including but not limited to the eye landmarks.

Returning to decision block 516 of FIG. 5B, if the eyelash extension is approved (e.g., by actuating the “create” interface element 1102 of FIG. 11), then the result of decision block 516 is YES, and the method 500 proceeds to block 518. At block 518, the extension creation engine 414 transmits instructions to an eyelash extension creation system 106 to cause the eyelash extension creation system 106 to apply an eyelash extension to the subject 104 based on the adjusted eyelash extension template. The instructions may include locations, lengths, shapes, and/or other aspects for lashes to be automatically applied to the subject 104 by the eyelash extension creation system 106 that correspond to the adjusted eyelash extension template.

The method 500 then proceeds to an end block and terminates.

While illustrative embodiments have been illustrated and described, it will be appreciated that various changes can be made therein without departing from the spirit and scope of the invention.

1. A computer-implemented method of creating an eyelash extension, the method comprising:
receiving, by a computing system, an image of a face of a subject;
detecting, by the computing system, one or more eye landmarks within the image;
adjusting, by the computing system, an eyelash extension template based on the one or more eye landmarks; and
generating, by the computing system, an augmented reality presentation that includes the image of the face of the subject and the adjusted eyelash extension template.

2. The computer-implemented method of claim 1, wherein generating the augmented reality presentation includes:
cropping, by the computing system, the image of the face of the subject to an eye region based on the one or more eye landmarks; and
detecting, by the computing system, one or more extension attachment points based on the cropped image of the eye region.

3. The computer-implemented method of claim 2, wherein the eyelash extension template includes a two-dimensional image of the eyelash extension; and
wherein generating the augmented reality presentation includes:
adjusting the two-dimensional image of the eyelash extension based on the adjusted eyelash extension template; and
rendering the adjusted two-dimensional image of the eyelash extension based on the one or more extension attachment points.

4. The computer-implemented method of claim 2, wherein the eyelash extension template includes a three-dimensional model of the eyelash extension; and
wherein generating the augmented reality presentation includes:
adjusting the three-dimensional model of the eyelash extension based on the adjusted eyelash extension template; and
rendering the adjusted three-dimensional model of the eyelash extension based on the one or more extension attachment points.

5. The computer-implemented method of claim 1, further comprising:
presenting, by the computing system, an interface for receiving a modification to one or more of a length of the eyelash extension template, a density of the eyelash extension template, a thickness of the eyelash extension template, or a curve of the eyelash extension template.

6. The computer-implemented method of claim 1, further comprising:
presenting, by the computing system, one or more recommended eyelash extension templates based on the detected eye landmarks.

7. The computer-implemented method of claim 1, further comprising:
transmitting, by the computing system, instructions to an eyelash extension creation system to cause the eyelash extension creation system to apply the eyelash extension to the subject based on the adjusted eyelash extension template.

8. A non-transitory computer-readable medium having computer-executable instructions stored thereon that, in response to execution by one or more processors of a computing system, cause the computing system to perform actions for creating an eyelash extension, the actions comprising:
receiving, by the computing system, an image of a face of a subject;
detecting, by the computing system, one or more eye landmarks within the image;
adjusting, by the computing system, an eyelash extension template based on the one or more eye landmarks; and
generating, by the computing system, an augmented reality presentation that includes the image of the face of the subject and the adjusted eyelash extension template.

9. The non-transitory computer-readable medium of claim 8, wherein generating the augmented reality presentation includes:
cropping, by the computing system, the image of the face of the subject to an eye region based on the one or more eye landmarks; and
detecting, by the computing system, one or more extension attachment points based on the cropped image of the eye region.

10. The non-transitory computer-readable medium of claim 9, wherein the eyelash extension template includes a two-dimensional image of the eyelash extension; and
wherein generating the augmented reality presentation includes:
adjusting the two-dimensional image of the eyelash extension based on the adjusted eyelash extension template; and
rendering the adjusted two-dimensional image of the eyelash extension based on the one or more extension attachment points.

11. The non-transitory computer-readable medium of claim 9, wherein the eyelash extension template includes a three-dimensional model of the eyelash extension; and
wherein generating the augmented reality presentation includes:
adjusting the three-dimensional model of the eyelash extension based on the adjusted eyelash extension template; and
rendering the adjusted three-dimensional model of the eyelash extension based on the one or more extension attachment points.

12. The non-transitory computer-readable medium of claim 8, wherein the actions further comprise:
presenting, by the computing system, an interface for receiving a modification to one or more of a length of the eyelash extension template, a density of the eyelash extension template, a thickness of the eyelash extension template, or a curve of the eyelash extension template.

13. The non-transitory computer-readable medium of claim 8, wherein the actions further comprise:
presenting, by the computing system, one or more recommended eyelash extension templates based on the detected eye landmarks.

14. The non-transitory computer-readable medium of claim 8, wherein the actions further comprise:
transmitting, by the computing system, instructions to an eyelash extension creation system to cause the eyelash extension creation system to apply the eyelash extension to the subject based on the adjusted eyelash extension template.

15. A computing system, comprising:
circuitry for receiving an image of a face of a subject;
circuitry for detecting one or more eye landmarks within the image;
circuitry for adjusting an eyelash extension template based on the one or more eye landmarks; and
circuitry for generating an augmented reality presentation that includes the image of the face of the subject and the adjusted eyelash extension template.

16. The computing system of claim 15, wherein generating the augmented reality presentation includes:
cropping the image of the face of the subject to an eye region based on the one or more eye landmarks; and
detecting one or more extension attachment points based on the cropped image of the eye region.

17. The computing system of claim 16, wherein the eyelash extension template includes a two-dimensional image of the eyelash extension; and
wherein generating the augmented reality presentation includes:
adjusting the two-dimensional image of the eyelash extension based on the adjusted eyelash extension template; and
rendering the adjusted two-dimensional image of the eyelash extension based on the one or more extension attachment points.

18. The computing system of claim 16, wherein the eyelash extension template includes a three-dimensional model of the eyelash extension; and
wherein generating the augmented reality presentation includes:
adjusting the three-dimensional model of the eyelash extension based on the adjusted eyelash extension template; and
rendering the adjusted three-dimensional model of the eyelash extension based on the one or more extension attachment points.

19. The computing system of claim 15, further comprising:
circuitry for presenting an interface for receiving a modification to one or more of a length of the eyelash extension template, a density of the eyelash extension template, a thickness of the eyelash extension template, or a curve of the eyelash extension template.

20. The computing system of claim 15, further comprising:
circuitry for transmitting instructions to an eyelash extension creation system to cause the eyelash extension creation system to apply the eyelash extension to the subject based on the adjusted eyelash extension template.
